(19) United States
(12) Patent Application Publication
(10) Pub. No.: US 2003/0066201 A1
(43) Pub. Date: Apr. 10, 2003

(54) Method and arrangement for measuring device

(75) Inventors: Hannu Moisio, Kangasala (FI); Timo Saikanmaki, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation Oy, Tampere (FI)

(21) Appl. No.: 10/228,775

(22) Filed: Aug. 27, 2002

(30) Foreign Application Priority Data
Aug. 28, 2001 (FI) 20011720

(51) Int. Cl. G01B 3/00

(52) U.S. Cl. 33/501.02

(57) ABSTRACT

The measuring device is arranged to measure at least one property of a moving web. The measuring device includes at least one measuring head with at least one measuring element arranged in a flexible membrane that surrounds the measuring element and is arranged in connection with the measuring head such that the measuring element is movable by means of the flexible membrane perpendicularly to the moving web. The turning effect, which is caused by the pressure of the air conveyed with the moving web, and directed in the travel direction of the web at least in front of the measuring element on the web side of the flexible membrane, and turns the measuring element, is prevented by at least partly changing the amount and/or flow direction of the air conveyed with the web moving to the measuring element.

### BACKGROUND OF THE INVENTION

1) Field of the Invention

The invention relates to a method for a measuring device, the measuring device being arranged to measure at least one property of a moving web and the measuring device including at least one measuring head with at least one measuring element arranged in a flexible membrane that surrounds the measuring element and is arranged in connection with the measuring head such that the measuring element is movable by means of the flexible membrane perpendicularly to the moving web.

The invention further relates to an arrangement for a measuring device, the measuring device being arranged to measure at least one property of a moving web, and the measuring device including at least one measuring head with at least one measuring element arranged in a flexible membrane that surrounds the measuring element and is arranged in connection with the measuring head such that the measuring element is movable by means of the flexible membrane perpendicularly to the moving web.

2) Description of Related Art

In papermaking, the quality of the paper, such as thickness, is measured as the paper web to be manufactured moves in the paper machine. Typically, the quality of the paper is measured with what are called traversing measuring devices comprising two measuring heads on opposites sides of the paper web and arranged in measuring carriages that traverse the paper web in its transverse direction over the entire width of the paper web. There is a small gap, i.e. an air gap between the measuring carriages, wherein the paper web travels at a high speed. The first measuring head usually comprises a fixedly disposed first measuring element, which the paper web traverses. Rolls comprised by the measuring carriage and used to support the paper web ensure that the contact of the paper with the measuring element is even. The second measuring head, in turn, comprises a measuring element that is arranged wherein with a flexible membrane and moves perpendicularly to the paper web, i.e. in what is known as the z direction, and takes shelter at paper discontinuances and when entering and leaving the paper web. In a measurement situation, the moving measuring element is transferred with a membrane actuator into contact with the surface of the paper. The flexible membrane may be directly fastened, e.g. by gluing, to the second measuring head, but usually the flexible membrane is fastened to a locking member surrounding it, by means of which locking member the whole constituted by the measuring element, the flexible membrane and the locking member is fastened to the measuring head.

As the paper web moves in the paper machine, a considerable amount of air is conveyed with the web. Particularly in fast paper machines, in which the paper web moves more than 1200 m/min, the air conveyed by the paper causes a pressure disturbance at the membrane of the moving measuring element, since the moving measuring element blocks the air flow in the air gap on its side of the paper web. Seen in the travel direction of the paper, a harmful phenomenon is caused as the flow is hindered at the measuring element that touches the paper. In this case, overpressure, i.e. ram air or ram pressure is generated in front of the measuring element on the inlet side of the airflow, and the magnitude of the pressure depends on the density and speed of the air. A maximum pressure is generated on an area of the width of the measuring element. The overpressure is decreased in the direction from the measuring element towards the incoming direction of the airflow. The force caused by this pressure resists the pressure behind the membrane, i.e. the measuring pressure directed to the membrane by a pressure adjustment device tending to press the membrane on the incoming side of the air flow away from the paper web, making the measuring element incline. A similar phenomenon also occurs behind the measuring element, i.e. on the exit side of the airflow. An underpressure is generated behind the measuring element and it also acts extensively in the area of the membrane. This underpressure helps the pressure behind the membrane, and as a result, the membrane tends to rise towards the paper on the exit side of the airflow. The overpressure created in front of the measuring element and the underpressure created behind the measuring element thus make the measuring element incline such that, seen in the travel direction of the paper web, the front edge of the measuring element is withdrawn from and the back edge closes on the web to be measured. This inclination has to be fixed by raising the pressure acting behind the membrane, which leads to a situation where the measuring pressure of the measuring element is higher than need be. This again causes a problem in situations where there are small parts, such as sticks, resin, holes or other irregularities on the surface of the paper, with which the measuring element collides. Because of the unnecessarily high pressure acting behind the membrane, the measuring element is unable to avoid these irregularities on the surface of the paper, whereby the measuring element causes holes and different surface defects to the paper.

### BRIEF SUMMARY OF THE INVENTION

The object of the present invention is to provide a solution to reduce the inclination of a measuring element, caused by the air conveyed with a moving web.

The method of the invention is characterized in that the turning effect, which is caused by the pressure of the air conveyed with the moving web, and directed in the travel direction of the web at least in front of the measuring element on the web side of the flexible membrane, and turns the measuring element, is prevented by at least partly changing the amount and/or flow direction of the air conveyed with the moving web to the measuring element.

The arrangement of the invention is characterized in that the arrangement includes at least one device arranged to prevent the turning effect, which is caused by the pressure of the air conveyed with the moving web, and directed in the travel direction of the web at least in front of the measuring element on the web side of the flexible membrane, and turns the measuring element, by at least partly changing the amount and/or flow direction of the air conveyed with the moving web to the measuring element.

The essential idea of the invention is to prevent the turning effect, which is caused by the pressure of the air conveyed with the moving web, and directed in the travel direction of the web at least in front of the measuring element on the web side of the flexible membrane, and turns the measuring element, by at least partly changing the amount and/or flow direction of the air conveyed with the moving web to the measuring element, in a measuring device, which is arranged to measure at least one property of the moving web and includes at least one measuring head with at least one measuring element arranged in a flexible membrane surrounding the measuring element, the membrane being arranged in the measuring head such that the measuring element is movable by means of the flexible membrane perpendicularly to the moving web. According to a preferred embodiment of the invention, the flexible membrane is arranged in a locking member surrounding it, by means of which locking member the whole constituted by the measuring element, the flexible membrane and the locking member is arranged in the measuring head. According to a second preferred embodiment of the invention, the amount and/or flow direction of the air conveyed with the moving web is changed by means of at least a first deflector arranged at the locking member before the measuring element. According to a third preferred embodiment of the invention, the turning effect, which is caused by the air conveyed with the moving web, and which is directed in the travel direction of the web after the measuring element on the web side of the flexible membrane, and turns the measuring element, is prevented by at least partly changing the amount and/or flow direction of the air conveyed with the moving web after the measuring element. According to a fourth preferred embodiment of the invention, the amount and/or flow direction of the air conveyed with the moving web after the measuring element is changed by means of at least one second deflector arranged in the locking member after the measuring element. According to a fifth preferred embodiment of the invention, the locking member and deflector form a single integral structure.

An advantage of the invention is that the pressure effect of the air conveyed with the moving web on the flexible membrane is reduced, whereby the inclination of the moving measuring element is reduced. This allows the measuring pressure acting behind the flexible membrane and generated with the pressure adjustment device to be lowered, and as a result, the measuring element is able to more easily avoid the irregularities on the surface of the web, decreasing holes or other defects created on the web. The solution thus utilizes the air conveyed with the paper to eliminate the harmful phenomenon caused by it. The deflector arranged in the locking member, preferably as a single integral structure with the locking member, enables an easy and inexpensive implementation of the solution, since the measurement principle or the structure of the measuring elements does not have to be changed in any way.

The solution of the invention is similar in the manufacture of paperboard and chemical pulp, and in the present specification, the term ‘paper’ refers not only to paper, but also to paperboard and chemical pulp.

### BRIEF DESCRIPTION OF THE SEVERAL VIEWS OF THE DRAWING(S)

In the following, the invention will be described in detail in the accompanying drawings, in which

FIG. 1 is a schematic side view in partial cross-section of a solution of the invention,

FIG. 2 is a schematic cross-sectional side view of a detail of a prior art measuring device,

FIG. 3 schematically shows an enlargement of the solution of FIG. 1, and

FIG. 4 schematically shows the solution of FIGS. 1 and 3 seen from above the measuring head.

### DETAILED DESCRIPTION OF THE INVENTION

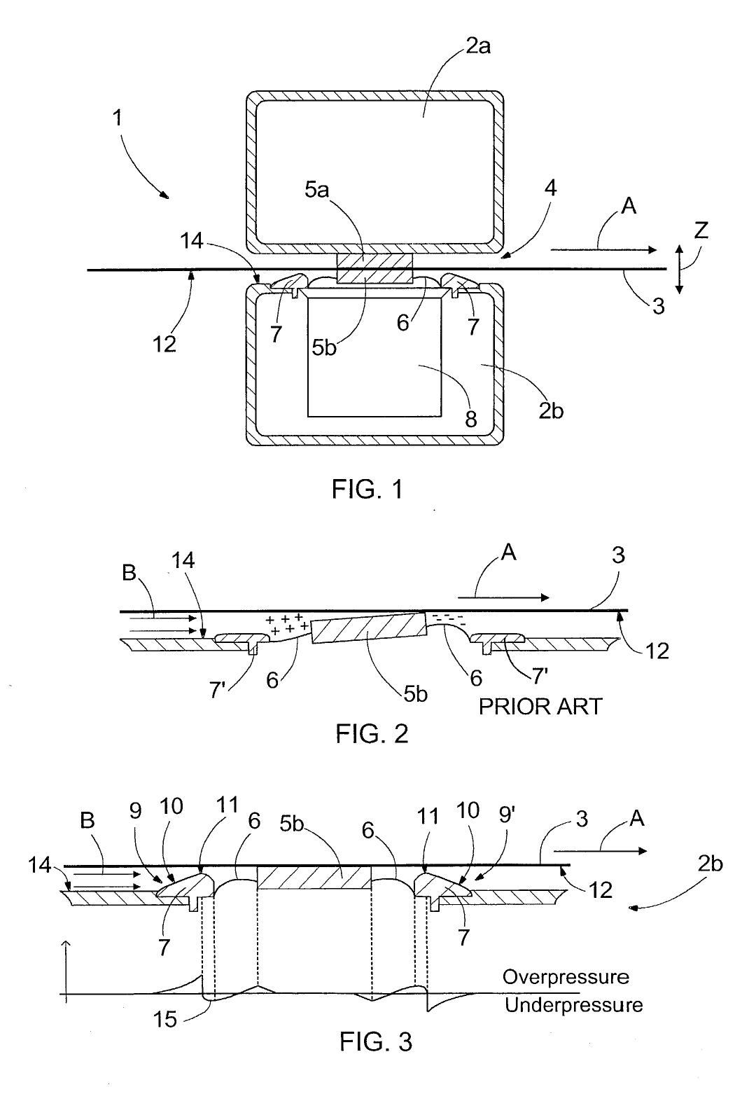

FIG. 1 is a schematic side view in partial cross-section of a measuring device measuring at least one property of a moving web. FIG. 1 shows a measuring device 1 arranged to measure the thickness of a paper web 3 as the web moves in the direction of arrow A, i.e. in the machine direction. For the sake of clarity, FIG. 1 shows the paper web 3 substantially thicker as it actually is as compared with the structure of the measuring device 1. The measuring device 1 includes a first measuring head 2a and a second measuring head 2b, between which is an air gap 4, where the paper web 3 moves. The measuring heads 2a and 2b may be fixedly mounted, thus measuring only one point of the paper web 3 in its lateral direction. However, usually the measuring heads 2a and 2b are arranged in measuring carriages that move along the beams of a measuring frame to and for transversely to the paper web 3 over the whole width of the paper web 3. For the sake of clarity, the measuring frame and the measuring carriages are not shown in FIG. 1. A first measuring element 5a, e.g. a coil, is fixedly arranged in the first measuring head 2a. The second measuring head 2b includes a second measuring element 5b, which is fastened to a flexible membrane 6 surrounding it, allowing the measuring element 5b to move perpendicularly to the paper web 3, i.e. in what is known as the z direction. The flexible membrane 6 allows the second measuring element 5b to move towards or away from the first measuring element 5a as the thickness of the paper web 3 varies. The measuring element 5b may be for instance a tablet, e.g. a sapphire-surfaced metal plate, made from a suitable material, allowing the distance between the measuring elements 5a and 5b and thus the thickness of the paper web 3 to be specified in a manner known per se to a person skilled in the art. The flexible membrane 6 is fastened to a locking member surrounding it, in this case a locking ring 7, by means of which the whole formed by the measuring element 5b, the flexible membrane 6 and the locking ring 7 can be fastened to the measuring head 2b. The flexible membrane 6 can be fastened to the measuring head 2b also for instance by gluing, whereby the locking member, in this case the locking ring 7, is not necessarily needed at all. The membrane 6 and the therein-arranged measuring element 5b are movable upwards or downwards, seen in FIG. 1, with a pressure adjustment device 8 arranged under the measuring element 5b and the membrane 6, in a manner known per se. FIG. 1 shows the measuring element 5b in an upper position, where it touches the paper web 3. However, the measuring element 5b is not necessarily in continuous contact with the paper web 3. Not only the second measuring element 5b, but also the first measuring element 5a can be arranged movable by means of the flexible membrane in the first measuring head 2a. Various measuring elements, i.e. probes and sensors, and the measurement of the thickness or another property of the paper web 3 by means of them are known per se to a person skilled in the art and are therefore not dealt with herein in any greater detail.

FIG. 2 is a schematic cross-sectional side view of a detail of the structure of a prior art measuring device. In the measuring device of FIG. 2, the locking ring 7′ surrounding the flexible membrane 6 has a very low structure. As a result, a large amount of air is allowed to flow with the moving paper web 3 over the locking ring 7′. This airflow, denoted by arrows B in FIG. 2, is blocked at the measuring element 5b, since the measuring element 5b blocks the airflow in the air gap 4 on its side of the paper web 3. As a result, overpressure, i.e. ram pressure is generated in front of the measuring element 5b, i.e. upstream of a measuring element, and it acts in an extensive area on the membrane 6, whereby the force caused by this pressure presses the flexible membrane 6 in front of the measuring element 5b downwards, making the measuring element 5b, seen in the travel direction of the paper web 3, incline downward at its front edge in the manner shown in FIG. 2. Furthermore, behind the measuring element 5b, i.e. downstream of a measuring element, the airflow B generates an underpressure, which also acts in an extensive area on the membrane 6. This underpressure helps the measuring pressure to be generated behind the membrane 6 with the pressure adjustment device 8, making the flexible membrane 6 behind the measuring element 5b rise, and as a result the rear edge of the measuring element 5b rises making the measuring element 5b incline further. Previously, attempts have been made to correct this inclination of the measuring element 5b by raising the measuring pressure acting behind the membrane 6. FIG. 2 shows the overpressure, i.e. ram pressure, generated in front of the measuring element 5b by plus signs (+) and the underpressure generated behind the measuring element by minus signs (−).

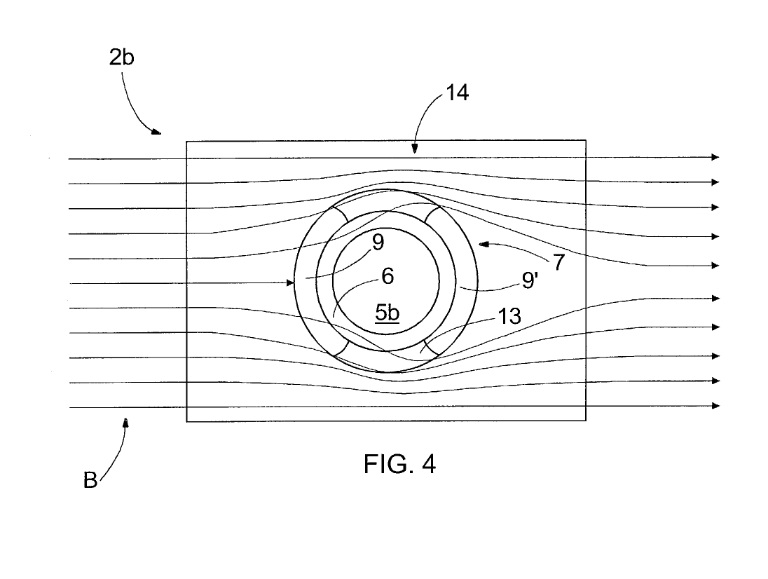

In the solution shown in FIG. 1, the locking ring 7 surrounding the flexible membrane 6 is provided on the front side of the measuring element 5b with a first deflector 9, which partly prevents the airflow B from reaching the measuring element 5b. For the sake of clarity, FIG. 3 shows an enlargement of the solution of FIG. 1. The lower part of FIG. 3 also schematically shows, by means of a pressure curve 15, the pressure effect of the air conveyed with the moving paper web 3 and directed to the web side of the flexible membrane 6 when the solution shown in FIGS. 1 and 3 is used. In FIG. 1 and 3, the deflector is arranged in the locking ring 7 such that the locking ring 7 and the deflector 9 are one integral structure. The deflector 9 may also be a separate part arranged in the locking ring 7. Laterally to the paper web 3, the width of the deflector 9 is preferably at least equal to that of the surface of the measuring element 5b that touches the surface of the paper web 3. FIG. 4 schematically shows the solution of FIGS. 1 and 3 seen from above the measuring head 2b.

The deflector 9 includes a smoothly rising slope 10 such that the summit 11 of the slope 10 rises close to the lower surface 12 of the paper web 3. The distance between the summit 11 and the lower surface 12 of the paper web 3 is preferably at most 0.2 mm. Compared with the upper surface 14 of the second measuring head 2b, the steepness of the slope 10 may vary. Preferably, the steepness of the slope 10 is at most 15 degrees. However, the slope 10 may also be steeper. Compared with the upper surface of the second measuring head 2b, the steepness of the slope 10 may be up to 90 degrees, and a rounding can be provided in the slope 10 before the summit 11, so that the deflector 9 does not include sharp edges that may damage the paper web 3 if it happened to touch the deflector 9. Accordingly, the only requirement is that the slope 10 be formed such that the slope 10 and the summit 11 do not damage the paper web 3 should the paper web 3 touch the locking ring 7. That part of the airflow B, which crosses the deflector 9 instead of bypassing it, creates an underpressure at and after the summit 11 of the deflector 9, seen in the travel direction of the paper web 3, the pressure acting in a large area on the surface of the flexible membrane 6 on the paper web 3 side. In this case, the force effect caused by the overpressure, i.e. ram pressure, generated by that part of the airflow B, which continues to be conveyed by the paper web 3 to the measuring element 5b, cannot exceed the force effect caused by the underpressure generated at and after the summit 11 of the deflector 9, which prevents the measuring element 5b from inclining at its front edge.

After the measuring element 5b, the locking ring 7 is provided with a second deflector 9′, corresponding to the deflector 9, and having a shape and dimensions corresponding to those of the deflector 9, which, however, is not absolutely necessary. The deflector 9′ decreases the airflow B on the exit side of the measuring element 5b, thus preventing underpressure from being generated on the paper web 3 side of the flexible membrane 6 behind the measuring element 5b. In this case, overpressure is generated in front of the exit side deflector 9′, whereby the underpressure otherwise generated behind the measuring element 5b over the membrane 6 is evened out.

That part of the airflow B, which under the influence of the deflector 9 turns from the travel direction of the paper web 3, causes underpressure between the deflectors 9 and 9′, in an open air duct 13 on a higher level than the upper surface 14 of the measuring head 2b, and a pressure lower than the air pressure acting on the surface of the membrane 6 on the paper web 3 side. Owing to the ducts 13, the open space evens out the pressure directed to the surface of the membrane 6 on the paper web 3 side. The effect of this pressure is symmetric in respect of the measuring element 5b, and thus it does not hinder the measurement, but in fact has a favorable effect, since it allows the measuring pressure behind the membrane 6 to be lowered.

An advantage of the invention is that the pressure directed by the air conveyed with the web to the flexible membrane 6, i.e. the effect of the force created by the pressure and, further, the thus caused inclination of the moving measuring element 5b is reduced. This allows the measuring pressure to be generated behind the flexible membrane 6 by the pressure adjustment device 8 to be lowered, and, consequently, the measuring element 5b does not have to be pressed with such a strong force against the paper web 3, and the measuring element 5b is better able to avoid the irregularities on the surface of the web and does not damage or otherwise injure the web. Thus, the solution utilizes the air conveyed by the web also to remove a harmful phenomenon. Since both the harmful phenomenon and the corrective effect are generated from the same flow, the corrective effect acts on a wide speed range. Furthermore, the inventive solution is not intended to be utilized by fast machines only, although, when used in them, the advantage provided by it is naturally maximized.

The drawings and the related specification are only intended to illustrate the inventive idea. The details of the invention may vary within the scope of the claims. Consequently, the locking ring 7 may be provided with a deflector only in front of the measuring element 5b. Preferably, the locking ring 7 is provided with deflectors in front of and behind the measuring element 5b. The deflector 9 can also be arranged to extend around the entire periphery of the locking ring 7. Furthermore, it is evident that the shape of the measuring element 5b, the flexible membrane 6 and the locking member surrounding it may deviate from the above-described circular shape, whereby the shape of the deflector is arranged to correspond to the shape of the measuring element 5b and the locking member. The deflectors 9 and 9′ may be arranged not only in the locking ring 7, but also on the upper surface 14 of the measuring head 2b, whereby the locking ring may be arranged movable, allowing it to be moved further away from the paper web to detach the measuring carriages moving the measuring heads 2a and 2b from each other. In addition, the web to be made does not necessarily have to be a paper web, but it can also be a plastic web, for example.

That which is claimed:

1. A method for positioning a measuring element of a measuring device, said measuring device configured to measure at least one property of a moving web and including a measuring head having a flexible membrane that supports the measuring element and that allows the measuring element to move with respect to the web, said method of positioning the measuring element comprising:
advancing the web in a web direction which causes air pressure at a position upstream of the measuring element, said air pressure causing a turning force on the measuring element; and
at least partly changing at least one of an amount and direction of air flow conveyed with the moving web to the measuring element so as to at least partially counteract the turning force of the measuring element by the air pressure.

2. A method as claimed in claim 1, wherein the flexible membrane is supported by a locking member surrounding it, from which locking member the whole formed by the measuring element, the flexible membrane and the locking member are supported by the measuring head.

3. A method as claimed in claim 2, wherein at least one of the amount and flow direction of the air conveyed with the moving web to the measuring element is changed with at least one first deflector arranged in connection with the locking member upstream of the measuring element.

4. A method as claimed in claim 1, wherein the turning force, which is caused by the pressure of the air conveyed with the moving web, and directed in the travel direction of the web after the measuring element on the web side of the flexible membrane, and turns the measuring element, is prevented by at least partly changing at least one of the amount and flow direction of the air conveyed with the moving web downstream of the measuring element.

5. A method as claimed in claim 4, wherein at least one of the amount and flow direction of the air conveyed with the moving web after the measuring element is changed with at least one second deflector arranged in connection with the locking member downstream of the measuring element.

6. A method as claimed in claim 3, wherein the deflector and the locking member are one integral structure.

7. A method as claimed in claim 5, wherein the deflector and the locking member are one integral structure.

8. A method as claimed in claim 1, wherein at least one of the amount and flow direction of the air conveyed with the moving web is changed at least over a width of a surface of the measuring element touching the moving web.

9. A method as claimed in claim 5, wherein the effect of the pressure directed to the flexible membrane on the side of the moving web is further evened out by an air duct between the first deflector and the second deflector.

10. A method as claimed in claim 1, wherein the property of the moving web to be measured is a thickness of the web.

11. A method as claimed in claim 1, wherein the moving web is one of a paper, paperboard and chemical pulp web.

12. A measuring device for measuring at least one property of a web moving in a web direction wherein movement of the web causes air pressure, said measuring device comprising:
at least one measuring head having at least one measuring element supported by a flexible membrane that allows the measuring element to move with respect to the moving web wherein the air pressure caused by the moving web is at least at a position upstream of the measuring element and exerts a turning force on the measuring element; and
at least one air deflector device positioned and shaped so as to at least partly change at least one of an amount and direction of air flow conveyed with the moving web to the measuring element so as to at least partially counteract the turning force on the measuring element by the air pressure.

13. A device as claimed in claim 12, wherein the device further includes a locking member supporting the flexible membrane, in which locking member the flexible membrane is arranged, and from which locking member the whole formed by the measuring element, the flexible membrane and the locking member is supported by the measuring head.

14. A device as claimed in claim 12, wherein the device includes at least one first deflector arranged to counteract the turning force, which is caused by the pressure of the air conveyed with the moving web, and directed in the travel direction of the web at least upstream of the measuring element on a web side of the flexible membrane, and turns the measuring element by at least partly changing at least one of the amount and flow direction of the air conveyed with the moving web to the measuring element.

15. A device as claimed in claim 14, wherein the first deflector is arranged in connection with the locking member.

16. A device as claimed in claim 12, wherein the device further includes at least one device arranged to counteract the turning force, which is caused by the pressure of the air conveyed with the moving web, and directed in the travel direction of the web downstream of the measuring element on a web side of the flexible membrane, and turns the measuring element, by at least partly changing at least one of the amount and flow direction of the air conveyed with the moving web downstream of the measuring element.

17. A device as claimed in claim 12, wherein the device further includes at least one second deflector arranged to counteract the turning force, which is caused by the pressure of the air conveyed with the moving web, and directed in the travel direction of the web downstream of the measuring element on the web side of the flexible membrane, and turns the measuring element, by at least partly changing at least one of the amount and flow direction of the air conveyed with the moving web downstream of the measuring element.

18. A device as claimed in claim 17, wherein the second deflector is arranged in connection with the locking member.

19. A device as claimed in claim 15, wherein the locking member and the deflector are a single integral structure.

20. A device as claimed in claim 18, wherein the locking member and the deflector are a single integral structure.

21. A device as claimed in claim 14, wherein the deflector includes a slope and a summit and that the deflector is arranged with respect to the moving web such that a distance between the moving web and the summit is at most 0.2 mm.

22. A device as claimed in claim 21, wherein a steepness of the slope is at most 15 degrees.

23. A device as claimed in claim 17, wherein the deflector includes a slope and a summit and the deflector is arranged with respect to the moving web such that a distance between the moving web and the summit is at most 0.2 mm.

24. A device as claimed in claim 23, wherein a steepness of the slope is at most 15 degrees.

25. A device as claimed in claim 13, wherein the locking member is a locking ring.

26. A device as claimed in claim 14, wherein laterally to the paper web, a width of the deflector is at least equal to a width of a surface of the measuring element that touches the paper.

27. A device as claimed in claim 17, wherein laterally to the paper web, a width of the deflector is at least equal to a width of the surface of the measuring element that touches the paper.

28. A device as claimed in claim 17, wherein between the first deflector and the second deflector is an air duct for further evening out the effect of the pressure directed to the flexible membrane on a side of the moving web.

29. A device as claimed in claim 12, wherein the property of the moving web to be measured is a thickness of the web.

30. A device as claimed in claim 12, wherein the moving web is one of a paper, paperboard and chemical pulp web.
